(19) United States
(12) Patent Application Publication
(10) Pub. No.: US 2017/0080530 A1
(43) Pub. Date: Mar. 23, 2017

(54) METHOD OF ELECTRON BEAM WELDING

(71) Applicants: MICHAEL DAVIS MCGHEE, LAKE WORTH, FL (US); ROBERT ZALESKI, BOYNTON BEACH, FL (US)

(72) Inventors: MICHAEL DAVIS MCGHEE, LAKE WORTH, FL (US); ROBERT ZALESKI, BOYNTON BEACH, FL (US)

(73) Assignees: MICHAEL DAVIS MCGHEE, LAKE WORTH, FL (US); ROBERT ZALESKI, BOYNTON BEACH, FL (US)

(21) Appl. No.: 14/861,751

(22) Filed: Sep. 22, 2015

(51) Int. Cl. B23P 6/00; B23K 15/00; F02C 7/22

(52) U.S. Cl. CPC B23P 6/005; F02C 7/222; B23K 15/0006; B23K 15/0046; F05D 2220/32; F05D 2230/80; B23P 2700/13; B23K 2201/001

(57) ABSTRACT

This disclosure describes an improved method of electron beam (“EB”) welding utilizing a collection pocket. The method includes providing a first surface and a second surface, forming a collection pocket in at least one of the first surface and the second surface, coupling the first surface to the second surface at a joining location, and EB welding the first surface and the second surface to each other at the joining location. The collection pocket captures and contains excess weld material to prevent the excess material from escaping the joining location, and also reduces an amount of wall thickness required for EB welding. A method of reconditioning gas turbine components is also disclosed.

### TECHNICAL FIELD

The field of the invention relates to electron beam (“EB”) welding.

### BACKGROUND OF THE INVENTION

Gas turbines include numerous components. These components may include a combustor for mixing air and fuel for ignition, a turbine blade and rotor assembly for producing power, and a fuel nozzle assembly for providing fuel to the combustor for operation of the gas turbine. Fuel nozzle assemblies in gas turbines often include a fuel nozzle end cover with at least one fuel nozzle insert that is brazed into the fuel nozzle end cover.

Gas turbine components, including fuel nozzle assemblies, are frequently located near the combustor and typically must withstand high temperatures for extended periods of time. As a result, durability limits of these components are often reached or exceeded, requiring replacement, repair, and/or reconditioning/refurbishing of the components for continued operation of the gas turbine.

Replacing, repairing, and/or reconditioning gas turbine components, including fuel nozzle inserts, is often challenging, due to the limitations of traditional brazing and EB welding. EB welding is useful in gas turbine assemblies because EB welded joints have increased ability to handle tension from thermal strain, compared to brazed joints. EB welded joints also have the ability to yield and distribute loads. However, traditional EB welding may require a geometric structure, such as a backing shelf or other geometric configuration, to work effectively. Additionally, there is a requisite loss of wall thickness and weakening of wall integrity required to form a backing shelf, a limited containment of excess weld material escaping the weld joints, and also a limited number of repairs that can be performed, due to loss of wall thickness. As a result, a new and improved method of EB welding is needed that addresses these problems, among others.

### SUMMARY

This summary presents a high-level overview of various aspects of the invention and a selection of concepts that are further described below in the detailed description section. This summary is not intended to identify key or essential features of the claimed subject matter, nor is it intended to be used as an aid in isolation to determine the scope of the claimed subject matter. The scope of the invention is defined by the claims.

In brief, and at a high level, this disclosure describes, among other things, an improved method of EB welding that reduces leakage of excess weld material, improves integrity of welded surfaces, and allows for greater versatility of EB welding, due to reduced geometric requirements. The method may include forming a collection pocket in at least one of a first and a second surface that are to be EB welded together, coupling the first and second surfaces together at an EB welding location, and EB welding the first and second surfaces together at the EB welding location. The collection pocket may be located at least partially between the first and second surfaces at the EB welding location to collect and retain excess weld material. The method may be used in tight-tolerance or thin-walled applications where EB welding with a backing shelf, which provides alignment and a barrier, may be difficult or impossible due to geometric constraints. The method, in one exemplary application, allows for improved replacement and reconditioning of a fuel nozzle insert in a fuel nozzle assembly of a gas turbine.

In a first embodiment, an electron beam (EB) welded turbine component is provided. The component comprises an insert, or a component thereof, and a receiving component comprising a base material that forms a cavity corresponding to a shape of at least a portion of the insert or the component thereof. The outer surface of the insert or the component thereof is EB welded to an inner surface of the cavity at a first location, and, at the first location, at least one of the outer surface of the insert or the component thereof and the inner surface of the cavity includes a collection pocket.

In a second embodiment, a method of reconditioning a turbine component with electron beam (EB) welding is provided. The method comprises providing a receiving component comprising a base material that forms a cavity having an inner surface, providing an insert or a component thereof having an outer surface, forming a collection pocket on at least one of the inner surface and the outer surface, coupling the inner surface to the outer surface at a first location, and EB welding the inner surface and the outer surface together at the first location.

In a third embodiment, a method of EB welding gas turbine components is provided. The method comprises providing a first component having a first surface, providing a second component having a second surface, forming a collection pocket in at least one of the first surface and the second surface, and EB welding the first surface to the second surface.

Although the EB welding methods, devices, and systems described in this disclosure are described in the context of gas turbine components, assemblies, and systems, the methods described herein may be used for joining any two surfaces where effective EB welding is desired, and should not be limited merely to components, assemblies, and systems of gas turbines.

### BRIEF DESCRIPTION OF THE SEVERAL VIEWS OF THE DRAWINGS

Illustrative embodiments of the present invention are described in detail below with reference to the attached drawing figures, wherein:

FIG. 1 depicts a partial, cross-sectional, perspective view of a fuel nozzle assembly with an end cover and multiple fuel nozzle inserts, in accordance with an embodiment of the present invention;

FIG. 2 depicts a partial, side elevation, fragmentary view of a fuel nozzle insert of FIG. 1 connected to a fuel passageway, in accordance with an embodiment of the present invention;

FIGS. 3A-3D depict perspective views of a set of components that together form an assembled fuel nozzle insert, in accordance with an embodiment of the present invention;

FIGS. 4A-4F depict an angled, perspective, cross-sectional view of a fuel nozzle end cover having a cavity in which a fuel nozzle insert is pre-installed, removed, and refurbished/reconditioned, respectively, in accordance with an embodiment of the present invention;

FIG. 5 depicts a traditional EB welding configuration utilizing a backing shelf, in accordance with an embodiment of the present invention;

FIGS. 6A-6B depict first and second exemplary EB welding configurations with an undercut geometry that forms a collection pocket, in accordance with an embodiment of the present invention;

FIG. 7 depicts an exemplary EB weld utilizing a collection pocket, in accordance with an embodiment of the present invention;

FIG. 8 depicts a block diagram of a method of reconditioning a turbine component with EB welding, in accordance with an embodiment of the present invention; and

FIG. 9 depicts a block diagram of a method of EB welding gas turbine components, in accordance with an embodiment of the present invention.

### DETAILED DESCRIPTION

The subject matter of the various embodiments of the present invention is described with specificity in this disclosure to meet statutory requirements. However, the description is not intended to limit the scope of invention. Rather, the claimed subject matter may be embodied in various other ways to include different features, components, elements, combinations, and steps, similar to the ones described in this document, and in conjunction with other present and future technologies. Terms should not be interpreted as implying any particular order among or between various steps unless the stated order of steps is explicitly required. Many different arrangements of the various components depicted, as well as use of components not shown, are possible without departing from the scope of the claims.

At a high level, the present invention generally relates to an improved method of EB welding that incorporates a collection pocket. The collection pocket may be formed in one or more surfaces that are to be EB welded together, to reduce the deposit of excess weld material around the EB weld, and also to reduce an amount of wall thickness required to form a secure EB weld connection, due to the reduced requirement for specific wall geometry (e.g., a backing shelf). For example, the method may be applied to replacement of an insert, such as a fuel nozzle insert in an assembly of a gas turbine. In such an example, a pre-installed insert, such as a fuel nozzle insert, may be removed from a receiving component, such as a fuel nozzle end cover, leaving a cavity, an outer surface of a fuel nozzle insert component may be coupled to an inner surface of the cavity at an EB welding location, and the outer surface may be EB welded to the inner surface at the EB welding location. Additionally, prior to EB welding the surfaces, a collection pocket may be formed on at least one of the inner surface and the outer surface, such that the collection pocket is at least partially between the inner and outer surfaces at the EB welding location. In this regard, in any application where two surfaces are being EB welded together, the collection pocket may be formed on one or both of the surfaces that are EB welded, such that in either scenario, the collection pocket is at least partially between the surfaces that are EB welded.

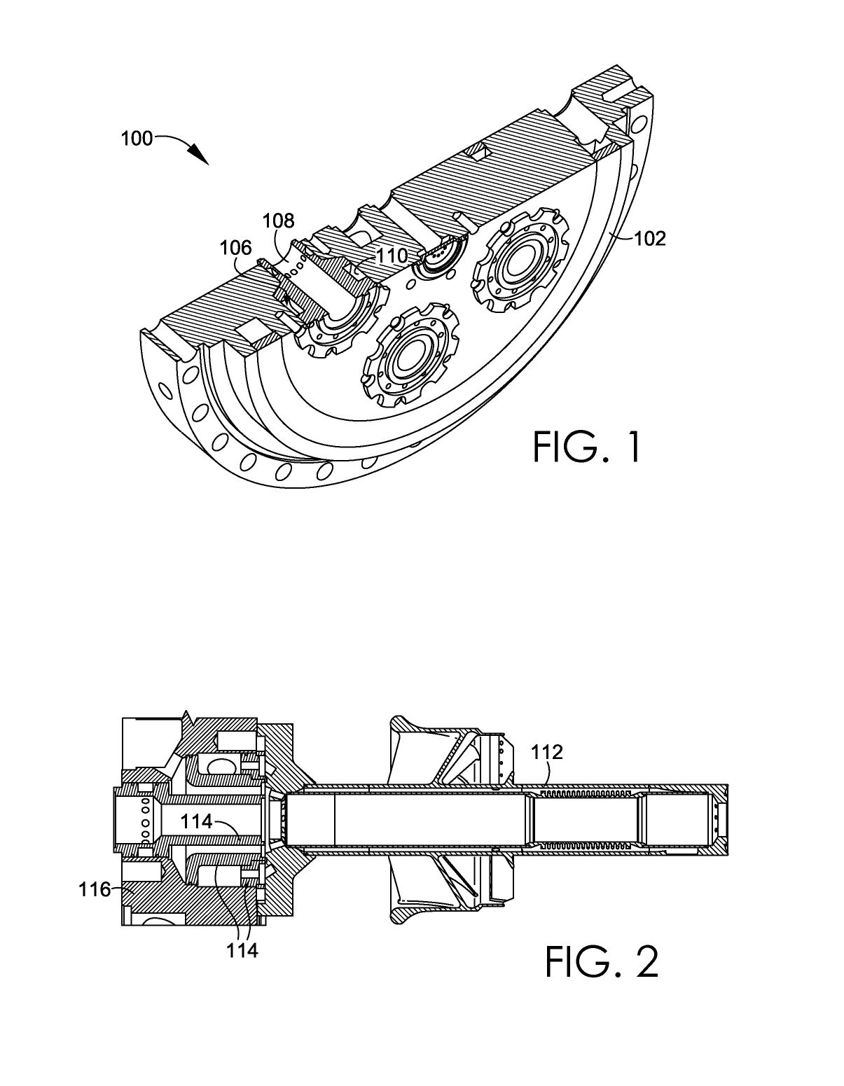

Having described some general aspects of the invention, reference is now made to FIG. 1, which depicts a partial, cross-sectional, perspective view of a fuel nozzle assembly 100 with an end cover 102 and multiple fuel nozzle inserts 108 located in the end cover 102, in accordance with an embodiment of the present invention. In FIG. 1, the end cover 102 includes a plurality of cavities 106 that are each configured to receive at least a portion of a corresponding fuel nozzle insert 108. The fuel nozzle insert 108 may be brazed, EB welded, or otherwise secured to an inner surface 110 of the cavity 106, and may, prior to installation, be provided as one or multiple components. The configuration of the end cover 102 shown in FIG. 1 may limit the ability to provide backing shelves for traditional EB welding of replacement fuel nozzle inserts 108 without causing thin wall issues between the fuel nozzle inserts 108 in the end cover 102. As a result, fewer repairs for replacing the fuel nozzle inserts 108 may be possible, due to the ever increasing proximity of the cavities 106 for the fuel nozzle inserts 108 in the end cover 102.

Referring now to FIG. 2, a partial, side elevation, fragmentary view of one of the fuel nozzle inserts 108 of FIG. 1 connected to a fuel passageway 112 is provided, in accordance with an embodiment of the present invention. In FIG. 2, the end cover 102 is shown with the cavity 106 formed such that it can receive at least a portion of the fuel nozzle insert 108. Further, the fuel nozzle insert 108 includes a plurality of components 114 which, when installed and assembled, form the fuel nozzle insert 108. The end cover 102 includes a base material 116 that forms a shape of the cavity 106. The fuel nozzle insert 108 is brazed, EB welded, or otherwise secured to the base material 116 at the cavity 106 to join the end cover 102 and the components 114 of the fuel nozzle insert 108.

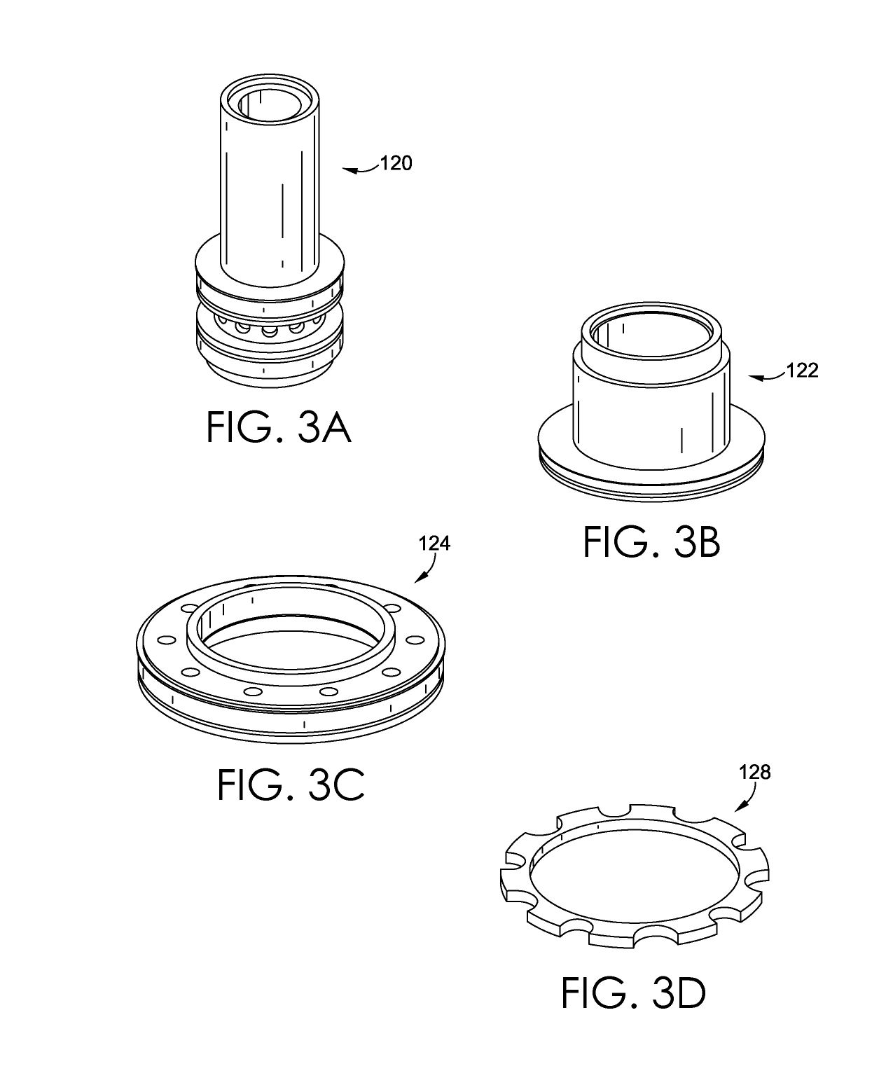

Referring now to FIGS. 3A-3D, a series of fuel nozzle insert components 120, 122, 124, 128 that may be EB welded to an end cover 102 to form an installed, assembled fuel nozzle insert 108 is provided, in accordance with an embodiment of the present invention. A traditional braze repair and reconditioning of a fuel nozzle insert 108 may be performed with a single insert. However, the EB welding method described herein may utilize multiple insert components 120, 122, 124, 128 that are distinct, as shown in FIGS. 3A-3D, allowing for a sequenced installation. FIG. 3A depicts a first component 120 which may be coupled and EB welded in a cavity 106 of the end cover 102. FIG. 3B depicts a second component 122 which may be coupled and EB welded in the cavity 106 of the end cover 102 at a location distinct from the first component 120. FIG. 3C depicts a third component 124 which may be coupled and EB welded in the cavity 106 of the end cover 102 at a location distinct from the first and the second components 120, 122. Additionally, FIG. 3D depicts a spacer 128 which may be installed at an opening 154 of the cavity 106 after assembly of the fuel nozzle insert 108 in the end cover 102 by EB welding the components 120, 122, 124 in place in the cavity 106.

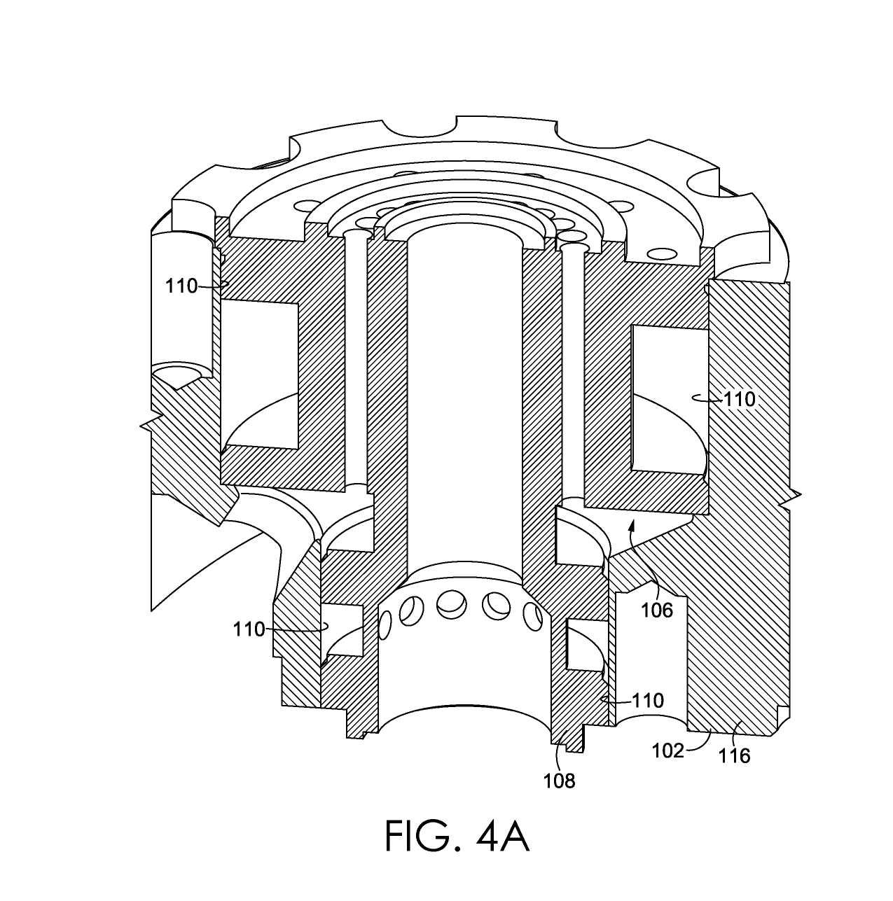

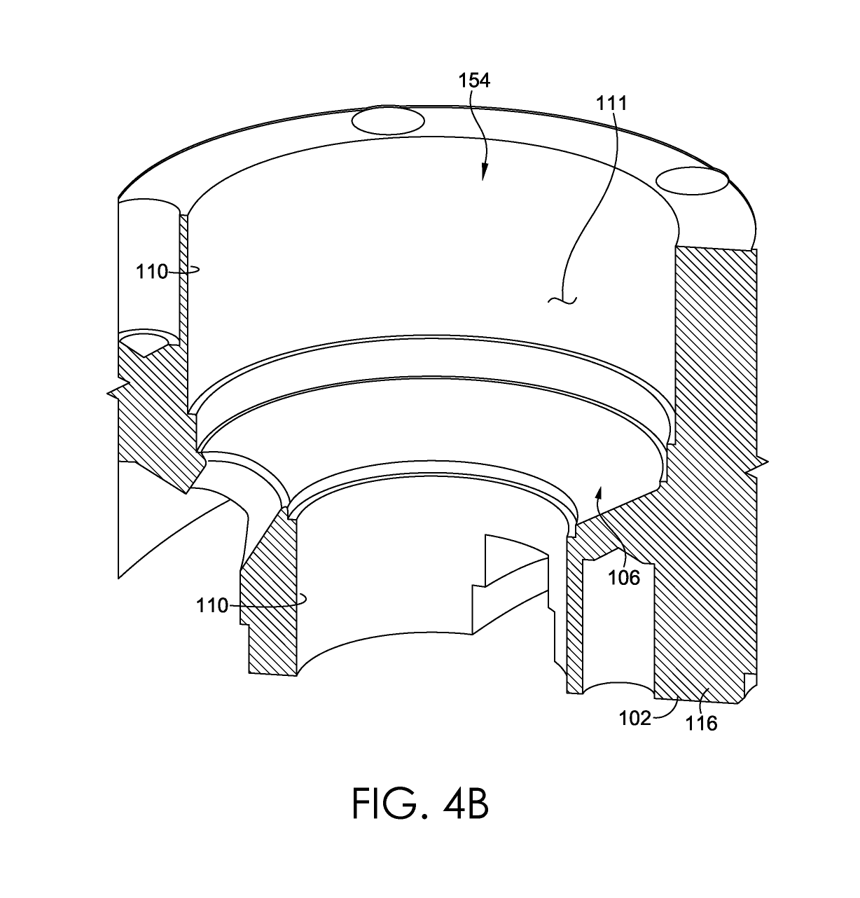

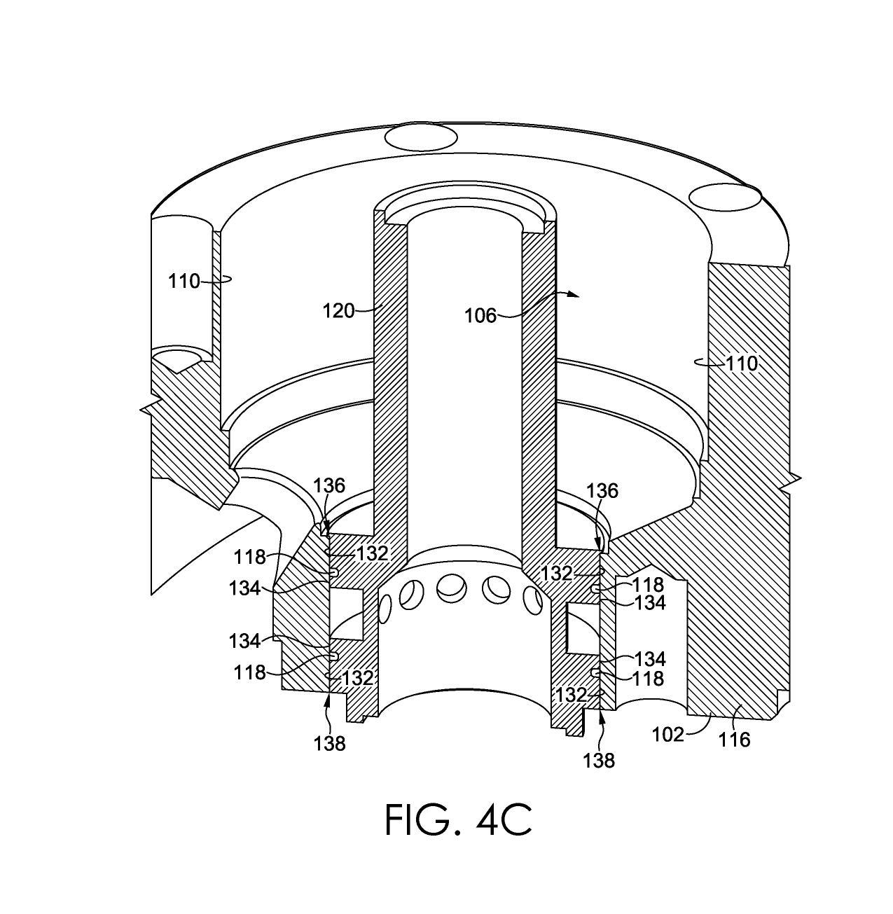

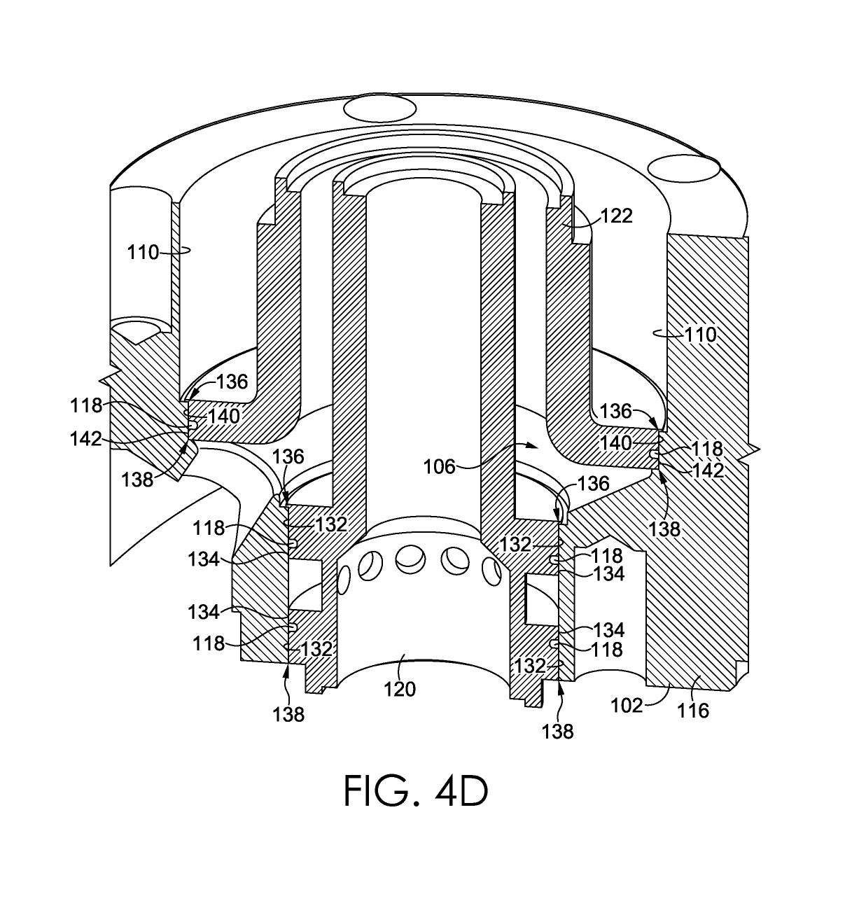

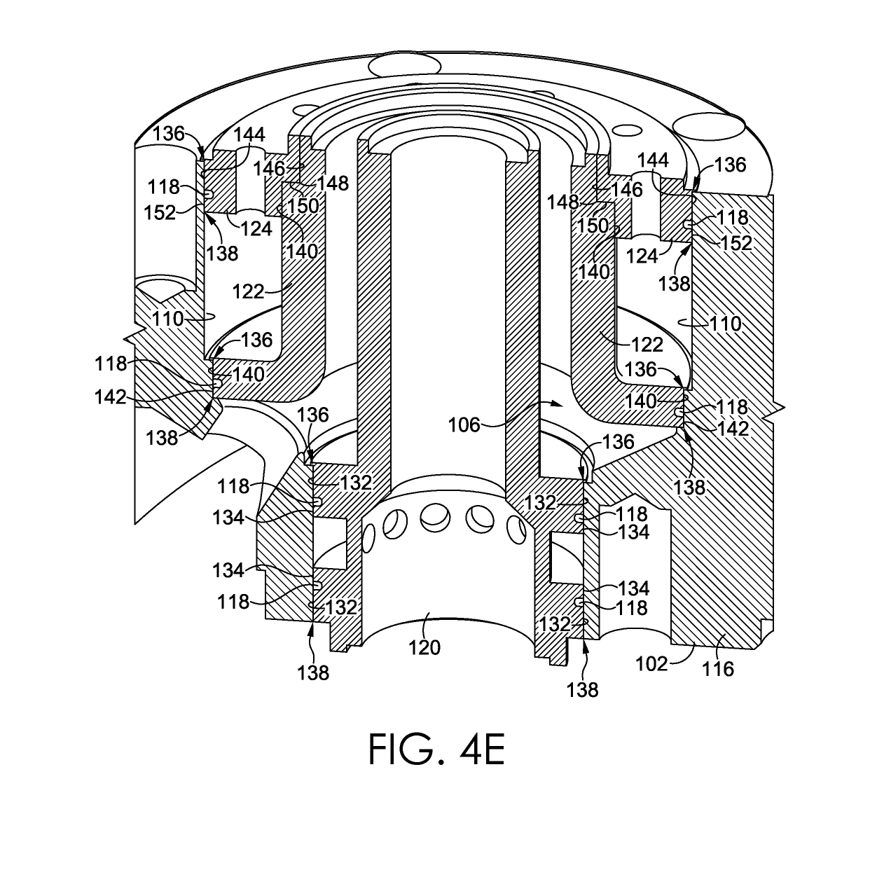

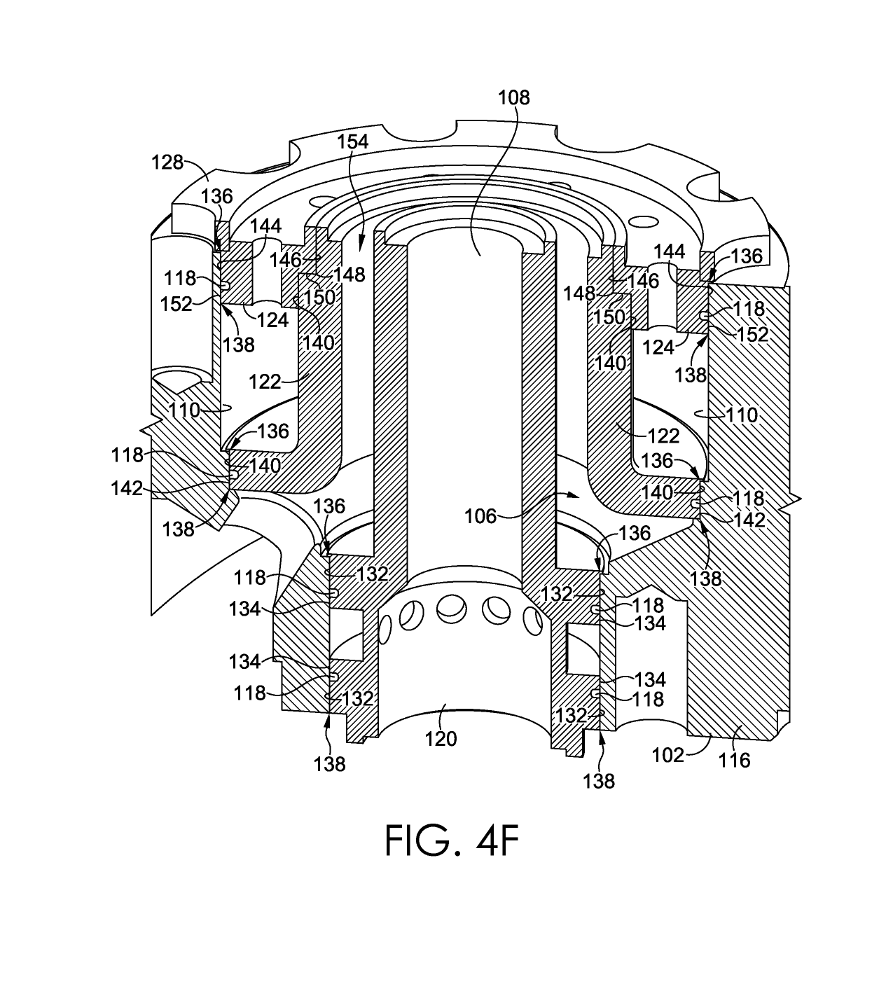

Referring now to FIGS. 4A-4F, an angled, perspective, cross-sectional view of a fuel nozzle end cover 102 having a cavity 106 in which a fuel nozzle insert 108 is pre-installed, removed, and refurbished/reconditioned, respectively, is provided, in accordance with an embodiment of the present invention. In FIG. 4A, the end cover 102 is shown with the fuel nozzle insert 108 brazed to the inner surface 110 of the cavity 106. FIG. 4B shows the cavity 106 after machining to remove the fuel nozzle insert 108, leaving the inner surface 110 of the cavity 106 exposed, and an opening 154 in the cavity 106. Further, by using the EB welding process described herein, only a minimal amount of wall thickness (i.e., base material 116) must be removed when extracting the fuel nozzle insert 108, due to the reduced welding surface geometry required for EB welding with a collection pocket 118 (as shown in FIGS. 4C-4F) instead of a backing shelf or other geometric feature.

FIG. 4C depicts an installation of a first component 120 of a fuel nozzle insert 108 in the cavity 106 of the end cover 102. The first component 120 includes an outer surface 132 on which a plurality of collection pockets 118, which may be curved indentations or depressions in the outer surface 132, are formed. The inner surface 110 of the cavity 106 and the outer surface 132 of the first component 120 are coupled at a first location 134, and the collection pocket 118 is disposed, or located, between the inner surface 110 of the cavity 106 and the outer surface 132 of the first component 120 at the first location 134.

The first location 134 may be described as a portion of the inner surface 110 of the cavity 106 and a portion of the outer surface 132 of the first component 120 that are in contact with each other, and between or in which the collection pocket 118 is disposed, or located. The first component 120, once coupled against the inner surface 110 of the cavity 106, may be EB welded from first and/or second ends 136, 138 of the first location 134, joining the material of the inner surface 110 and the outer surface 132 at the first location 134. As the EB welding is performed, even without a backing shelf or other geometric feature built into the surfaces 110, 132, the collection pocket 118 may help to receive, retain, collect, and store excess weld material (e.g., weld blow, weld spatter, weld leakage, etc.) escaping the first location 134. In gas turbine assemblies, excess weld material outside of EB welded joints may interfere with operation of the gas turbine, or cause detrimental effects to the gas turbine, and as a result, it is desirable to avoid such excess material buildup. Reducing excess weld material and maintaining maximum wall thickness by EB welding with a collection pocket may allow for repeated reconditioning processes, as well as protection of internal components, which may extend the life of the end cover 102 or another gas turbine component which is EB welded.

FIG. 4D depicts an installation of a second component 122 of the fuel nozzle insert 108 in the cavity 106 of the end cover 102. The second component 122 includes an outer surface 140 on which a collection pocket 118, which may be a curved indentation or depression in the outer surface 140 of the second component 122, is formed. The inner surface 110 of the cavity 106 and the outer surface 140 of the second component 122 are coupled at a second location 142 that is separate from the first location 134. The collection pocket 118 is disposed, or located, between the inner surface 110 of the cavity 106 and the outer surface 140 of the second component 122 at the second location 142. The second location 142 may be described as a portion of the inner surface 110 and a portion of the outer surface 140 that are in contact with each other, so that EB welding of the surfaces 110, 140 may occur, and between or against which the collection pocket 118 is positioned or formed. EB welding may be performed from either end 136, 138 of the second location 142, to join the outer surface 140 of the second component 122 and the inner surface 110 of cavity 106 at the second location 142.

FIG. 4E depicts an installation of a third component 124 of the fuel nozzle insert 108 in the cavity 106 of the end cover 102. The third component 124 includes an outer surface 144 on which a collection pocket 118, which may be a curved indentation or depression in the outer surface 144 of the third component 124, is formed. The third component 124 further includes an inner surface 146 that is coupled to the outer surface 140 of the second component 122 at a third location 148, the coupling including a traditional backing shelf 150 where excess material from EB welding at the third location 148 may be collected and contained. Additional EB welding may be performed between the inner surface 146 of the third component 124 and the outer surface 140 of the second component 122 at the third location 148.

Furthermore, the inner surface 110 of the cavity 106 and the outer surface 144 of the third component 124 are coupled at a fourth location 152 that is separate from the first, second, and third locations 134, 142, 148. A collection pocket 118 is disposed, or located, between the inner surface 110 of the cavity 106 and the outer surface 144 of the third component 124 at the fourth location 152. The fourth location 152 may be described as a portion of the inner surface 110 of the cavity 106 and a portion of the outer surface 144 of the third component 124 that are in contact with each other, so that EB welding of the surfaces 110, 144 can occur, and between or against which the collection pocket 118 is located. EB welding may occur from first or second ends 136, 138 of the fourth location 152, to join the outer surface 144 of the third component 124 and the inner surface 110 of the cavity 106. FIG. 4F depicts an installation of the spacer 128, which may be welded or otherwise coupled around an opening 154 of the cavity 106 in the end cover 102.

In the assembly process illustrated in FIGS. 4C-4F, it should be noted that the collection pocket 118 may be at least partially positioned, formed, or located on either or both surfaces at each EB welding location, including the first, second, and fourth locations 134, 142, 152. For example, at the first location 134 where the outer surface 132 of the first component 120 and the inner surface 110 of the cavity 106 are joined, the collection pocket 118, although depicted as formed in the outer surface 132 of the first component 120, may alternatively or additionally be formed in the inner surface 110 of the cavity 106. Additionally, one or multiple collection pockets 118 may be used in each weld location. The collection pocket 118 may also include a curved contour (shown in FIGS. 6A and 6B), which may help to collect and channel excess weld material into the collection pocket 118. Furthermore, the collection pocket 118 may be formed at each EB welding location such that it is in fluid communication with the EB weld so that it can receive, collect, and retain at least a portion of any excess weld material generated from the EB welding of the corresponding surfaces.

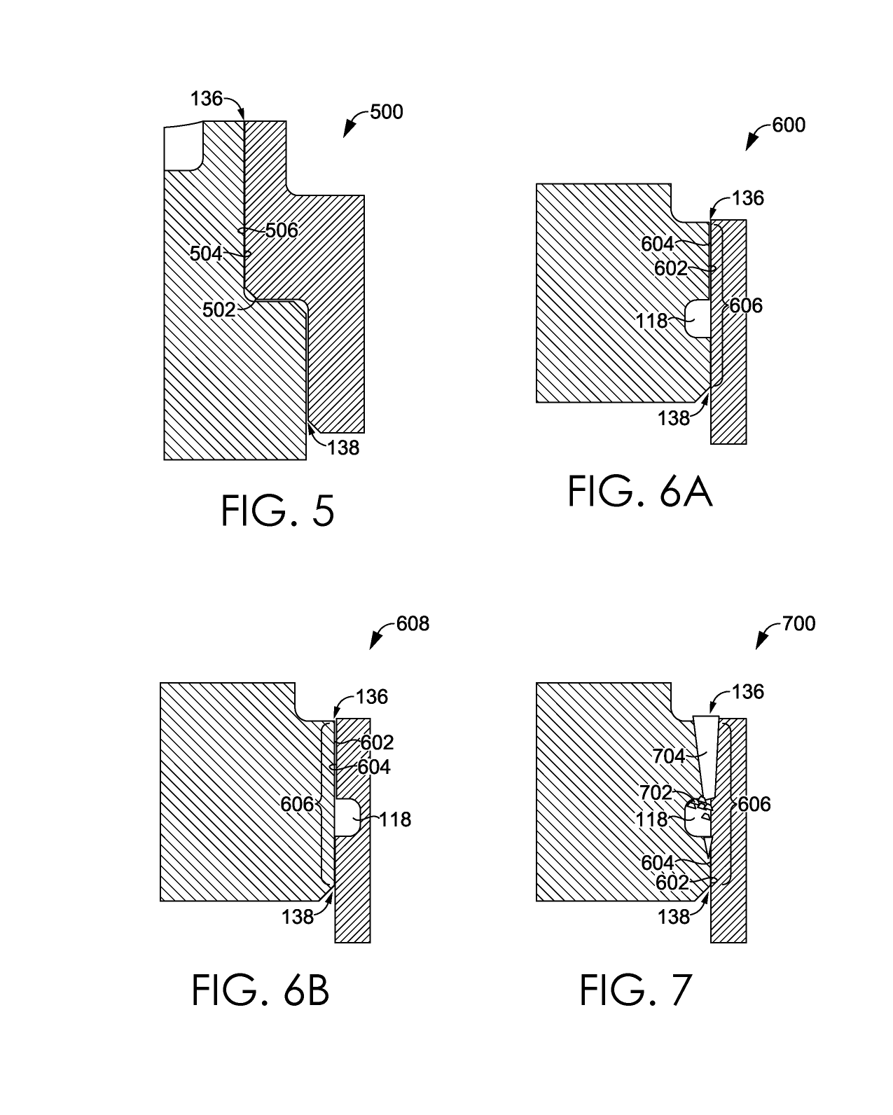

Referring now to FIG. 5, an exemplary traditional EB welding configuration 500, as used in the third location 148 shown in FIG. 4E, utilizing a backing shelf 502, is provided, in accordance with an embodiment of the present invention. In FIG. 5, a first surface 504 is coupled to a second surface 506. The first surface 504 and the second surface 506 each include a multi-directional geometry that forms a backing shelf 502 which may be used to control an amount of excess weld material escaping from at least one of the ends 136, 138 of the weld, and help secure the first surface 504 to the second surface 506.

Referring now to FIGS. 6A and 6B, an exemplary EB weld configuration 600 with an undercut geometry that forms a collection pocket 118 is provided, in accordance with an embodiment of the present invention. As described herein, the collection pocket 118 is an integrated feature of first and second surfaces 602, 604 of the weld configuration 600. As shown in FIG. 6A, the first surface 602 is coupled to the second surface 604, and the collection pocket 118 is formed or shaped into the first surface 602, such that the first and second surfaces 602, 604 can be EB welded together at an EB welding location 606 with the collection pocket 118 between the first and the second surfaces 602, 604. In this respect, the collection pocket 118 may collect excess weld material generated from EB welding the first and second surfaces 602, 604 at least partially together at the EB welding location 606.

The EB welding location 606 may be described as the length between the first end 136 and the second end 138 along which the first and second surfaces 602, 604 are coupled and EB welded. The EB welding may be performed from either end 136, 138 of the EB welding location 606, including both ends, depending on the geometric arrangement of components and structures to which the first and second surfaces 602, 604 are joined (i.e., the accessibility of each end 136, 138 for performing EB welding). FIG. 6B shows an alternative configuration 608 where the collection pocket 118 is formed or shaped into the second surface 604, instead of the first surface 602.

The collection pocket 118 may be formed or constructed to include different shapes, sizes, and/or orientations. For example, the collection pocket 118 may have straight portions, curved portions, or be defined by shapes formed in adjacent surfaces joined together for EB welding. Additionally, the collection pocket 118 may be circular, ovular, elliptical, square, rectangular, and/or symmetrical or asymmetrical. Additionally, the collection pocket 118 may be positioned on the inner surface 110 of the cavity 106 and may be oriented towards an interior 111 of the cavity 106, or the collection pocket 118 may be positioned on an outer surface (e.g., outer surface 132) of an insert component (e.g., component 120) and may be oriented away from the interior 111 of the cavity 106, as exemplified in FIGS. 4C-4F.

Referring now to FIG. 7, an exemplary EB weld 700 utilizing a collection pocket 118 is provided, in accordance with an embodiment of the present invention. In FIG. 7, an EB welded portion 704 is formed from the first end 136 of the EB welding location 606. Further, FIG. 7 depicts the EB welded portion 704 joining a portion of the first and second sides 602, 604 during the associated EB welding process. As the first and second sides 602, 604 are EB welded together, excess weld material 702 produced from EB welding the first and second sides 602, 604 is deposited into the collection pocket 118, rather than out the second end 138 of the EB welding location 606. This helps to reduce buildup of the excess weld material 702 outside of the EB welding location 606. As shown in FIG. 7, the EB welded portion 704 forms a tapered, or nail-like, shape in the first and second surfaces 602, 604.

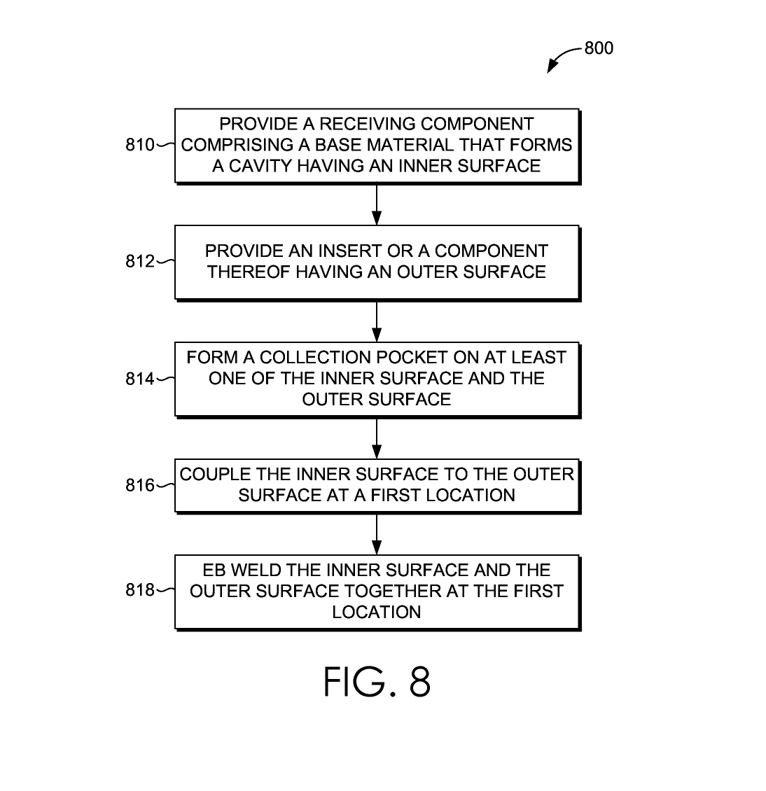

Referring now to FIG. 8, a block diagram of a method 800 of reconditioning a turbine component with EB welding is provided, in accordance with an embodiment of the present invention. At a block 810, a receiving component, such as the fuel nozzle end cover 102 shown in FIG. 1, is provided, the receiving component comprising a base material, such as the base material 116 shown in FIG. 2, that forms a cavity, such as the cavity 106 shown in FIG. 2, having an inner surface, such as the inner surface 110 shown in FIG. 2. At a block 812, an insert, such as the fuel nozzle insert 108 shown in FIG. 1, or a component thereof, such as the first, second, or third components 120, 122, 124 shown in FIG. 4F, having an outer surface, such as one of the outer surfaces 132, 140, 144 shown in FIG. 4F, is provided. At a block 814, a collection pocket, such as the collection pocket 118 shown in FIG. 4F, is formed on at least one of the inner surface and the outer surface. At a block 816, the inner surface is coupled to the outer surface at a first location, such as the first location 134 shown in FIG. 4F. At a block 818, the inner surface and the outer surface are EB welded together at the first location.

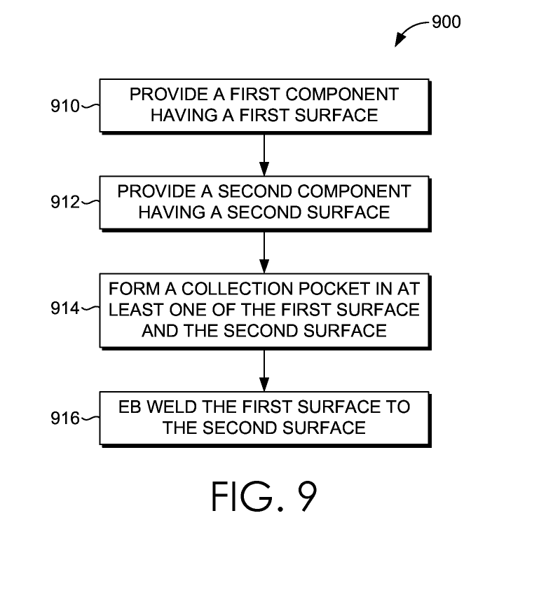

Referring now to FIG. 9, a block diagram of a method 900 of EB welding gas turbine components is provided, in accordance with an embodiment of the present invention. At a block 910, a first component, such as the first component 120 shown in FIG. 4F, having a first surface, such as the outer surface 132 shown in FIG. 4F, is provided. At a block 912, a second component, such as the end cover 102 shown in FIG. 4F, having a second surface, such as the outer surface 110 in the cavity 106 shown in FIG. 4F, is provided. At a block 914, a collection pocket, such as the collection pocket 118 shown in FIG. 4F, is formed in at least one of the first surface and the second surface. At a block 916, the first surface is EB welded to the second surface.

A system for reconditioning a turbine component with EB welding is also provided, in accordance with an embodiment of the present invention. The system may comprise a fuel nozzle end cover comprising a base material that forms a cavity having an inner surface, and a fuel nozzle insert or a plurality of components thereof, wherein the fuel nozzle insert or the plurality of components thereof include a respective outer surface that is EB welded to the inner surface of the cavity at a separate location. Additionally, at each separate location, one of the inner surface of the cavity and the outer surface of the fuel nozzle or respective component thereof includes a collection pocket.

Removal of pre-installed fuel nozzle inserts in the end cover, and installation of a replacement fuel nozzle insert, may be performed in multiple steps. For example, for an existing brazed insert, or otherwise installed insert, a horizontal boring mill, or other device, may be used to remove the pre-installed insert and leave a semi-finished cavity. Next, a vertical boring machine, or other device, may be used to provide a machined finish to the cavity. Then, the inner surface of the resulting cavity may be further prepared as needed for proper EB welding (e.g., polishing, finishing, stress relief, heat treating, etc.), and installing of the components may be commenced. After completing the EB welding process, additional pressure testing, heat treating, or polishing may occur to provide a fully finished, reconditioned fuel nozzle insert.

A further exemplary process of replacing or reconditioning a fuel nozzle insert may include rough machining a pre-installed fuel nozzle insert to remove at least a portion of the material forming the pre-installed insert, final machining the cavity in which the pre-installed insert was located, cleaning the cavity, EB welding new components into the cavity to form the replacement fuel nozzle insert in the cavity, heat treating the new fuel nozzle insert and end cover, and final machining the fuel nozzle insert and end cover. Additionally, pressure testing, visual inspection, and other testing may be performed. After completion of the replacement, final assembly and final inspection of the fuel nozzle assembly may be performed, as well as flow testing and flow adjustments.

In addition to combustion end covers and fuel nozzle inserts, the methods described herein may be utilized for EB welding other turbine components and assemblies, in addition to other non-gas turbine related surfaces and components. Such additional components and assemblies of gas turbines may include fuel nozzles, transition duct picture frames, blade squealer tips, or any other turbine component assembly or component that may be welded or brazed.

The collection pocket described herein may be incorporated into a variety of welding applications. One such welding application is the construction of a fuel nozzle assembly in a gas turbine, as described above. Additionally, EB welding utilizing a collection pocket may be used to improve traditional EB welding with a backing shelf. Non-limiting examples of EB welding with a collection pocket include joining airfoils and shrouds, fuel manifold construction, fuel nozzle tip attachment, connection of tubing, and/or any other scenario in which one turbine component is inserted in, and/or coupled to, another turbine component in order to EB weld the turbine components together.

Embodiments of the technology have been described herein to be illustrative rather than restrictive. Alternative embodiments will become apparent to readers of this disclosure. Further, alternative means of implementing the aforementioned elements and steps can be used without departing from the scope of the claims, as would be understood by one having ordinary skill in the art. Certain features and sub-combinations are of utility and may be employed without reference to other features and sub-combinations, and are contemplated as within the scope of the claims.

The invention claimed is:

1. An electron beam (EB) welded turbine component, the turbine component comprising:
an insert or a component thereof; and
a receiving component comprising a base material that forms a cavity corresponding to a shape of at least a portion of the insert or the component thereof,
wherein an outer surface of the insert or the component thereof is EB welded to an inner surface of the cavity at a first location, and
wherein, at the first location, at least one of the outer surface of the insert or the component thereof and the inner surface of the cavity includes a collection pocket.

2. The component of claim 1, wherein the insert is a fuel nozzle insert, and wherein the receiving component is a fuel nozzle end cover.

3. The component of claim 2, wherein the collection pocket includes a curved contour.

4. The component of claim 2, wherein the fuel nozzle insert comprises a plurality of distinct components that are each EB welded to the cavity at a separate location to form an assembled fuel nozzle insert that is at least partially received within the cavity.

5. The component of claim 4, wherein, at each separate location, at least one of the inner surface of the cavity and an outer surface of a respective distinct component of the plurality of distinct components includes a collection pocket.

6. The component of claim 2, wherein the collection pocket comprises an indented, curved depression in the inner surface of the cavity, and wherein an opening of the collection pocket is oriented towards an interior of the cavity.

7. The component of claim 2, wherein the collection pocket comprises an indented, curved depression in the outer surface of the fuel nozzle insert or the component thereof, and wherein an opening of the collection pocket is oriented away from an interior of the cavity.

8. The component of claim 2, wherein, at the first location, the collection pocket contains excess weld material from the EB welded inner and outer surfaces.

9. A method of reconditioning a turbine component with electron beam (EB) welding, the method comprising:
providing a receiving component comprising a base material that forms a cavity having an inner surface;
providing an insert or a component thereof having an outer surface;
forming a collection pocket on at least one of the inner surface and the outer surface;
coupling the inner surface to the outer surface at a first location; and
EB welding the inner surface and the outer surface together at the first location.

10. The method of claim 9, wherein the insert is a fuel nozzle insert, and wherein the receiving component is a fuel nozzle end cover.

11. The method of claim 10, wherein the collection pocket includes a curved contour.

12. The method of claim 10, wherein the collection pocket is at least partially between the inner surface and the outer surface at the first location when the inner surface and the outer surface are coupled and EB welded together at the first location.

13. The method of claim 10, further comprising removing a pre-installed fuel nozzle insert prior to coupling and EB welding the inner surface and the outer surface together at the first location.

14. The method of claim 10, wherein the fuel nozzle insert comprises a plurality of distinct components, and wherein the method further comprises EB welding an outer surface of each of the plurality of distinct components to the inner surface of the cavity at a separate location.

15. The method of claim 14, further comprising, at each separate location, forming a collection pocket on at least one of the inner surface of the cavity and the outer surface of the respective distinct component prior to EB welding.

16. The method of claim 10, wherein the collection pocket comprises an indented, curved depression in the inner surface of the cavity, and wherein an opening of the collection pocket is oriented towards an interior of the cavity.

17. The method of claim 10, wherein the collection pocket comprises an indented, curved depression in the outer surface of the fuel nozzle insert or the component thereof, and wherein an opening of the collection pocket is oriented away from an interior of the cavity.

18. The method of claim 10, further comprising performing at least one of pressure testing and heat treating at the first location.

19. The method of claim 10, wherein the EB welding occurs from at least one of a first end and a second end of the first location.

20. A method of electron beam (EB) welding gas turbine components, the method comprising:
providing a first component having a first surface;
providing a second component having a second surface;
forming a collection pocket in at least one of the first surface and the second surface; and
EB welding the first surface to the second surface.

21. The method of claim 20, wherein the first surface and the second surface are metal, wherein the collection pocket includes a curved contour, and wherein the collection pocket is at least partially between the first surface and the second surface.

22. The method of claim 20, wherein the collection pocket contains excess weld material from the EB welding of the first surface to the second surface.
